(19) United States
(12) Patent Application Publication
(10) Pub. No.: US 2015/0226412 A1
(43) Pub. Date: Aug. 13, 2015

(54) APPARATUS AND SYSTEM FOR SAFELY LOWERING AND RAISING LIGHT POLES

(71) Applicant: Hans Broere, Wetaskiwin (CA)

(72) Inventor: Hans Broere, Wetaskiwin (CA)

(21) Appl. No.: 14/599,950

(22) Filed: Jan. 19, 2015

Related U.S. Application Data
(60) Provisional application No. 61/928,838, filed on Jan. 17, 2014.

(51) Int. Cl. F21V 21/29; F21V 21/36; E04H 12/18; F21S 6/00

(52) U.S. Cl. CPC F21V 21/29; F21S 6/005; F21V 21/36; E04H 12/187

(57) ABSTRACT

The present disclosure relates to a system for safely lowering and raising a pole mounted lighting fixture. In an embodiment, the system comprises a pivoting pole mount having a first section and a second section, the second section rotatably hinged to the first section; and one or more shock absorbers, each shock absorber having a first end rotatably mounted to a first pivot point on the first section of the pivoting pole mount, and a second end rotatably mounted to a second pivot point on the second section of the pivoting pole mount. In use, the one or more shock absorbers counteract forces of rotation created when the first section and the second section of the pivoting pole mount are rotated relative to each other to decrease the distance between the first pivot point and the second pivot point.

### FIELD OF THE INVENTION

The present disclosure relates generally to a novel apparatus and system for safely lowering and raising light poles.

### BACKGROUND

Conventional lighting applications may often require the use of a pole, post or stanchion to mount a raised light fixture. If mounted at ground level, the lighting fixture may usually be reached by any number of conventional means, including compact mobile boom lifts or scissor lifts, for example.

However, when the pole lighting application is required in elevated locations, such as may be found in industrial situations such as raised catwalks or platforms in plants, refineries, etc., there is no ability to use these conventional means to reach the lighting fixtures.

Therefore, various prior art solutions have been proposed in which a pole is adapted to be telescopically raised or lowered, or made to swivel or pivot for access to the lighting. However, a common problem with prior art solutions is that the weight of the pole and lighting fixture may make the raising and lowering operation very challenging, especially where the weight of the lighting fixture and the pole may cause the assembly to collapse or swing out of control, and potentially cause serious injuries. In some cases, fixture mounts may break as well, causing the fixture and assembly to crash from heights that could inflict serious harm to personnel below.

Therefore, what is needed is an improved design for raising and lowering a pole mounted lighting fixture which addresses some of the limitations in the prior art.

### SUMMARY

The present disclosure relates to a novel apparatus and system for safely lowering and raising a pole mounted lighting fixture.

In an embodiment, the system comprises a pivoting pole mount including one or more shock absorbers adapted to counter-balance the forces of momentum created in the pivoting pole mount when the pole mount, in use, is attached to a base and to a pole having a light fixture mounted thereto.

A locking plate is used to lock the assembly into a vertical position when the pole is completely raised, and may be locked in position by a pin lock, for example.

By suitably selecting and calibrating the one or more hydraulic shock absorbers and one or more compression springs to counteract the weight of the pole and the pole mounted lighting fixture, the pole lowering operation can be initiated and controlled by one person with one hand, and no longer requires the person to physically try to counteract the forces himself.

Thus, in an aspect, there is provided a system for safely lowering and raising a pole mounted lighting fixture, comprising: a pivoting pole mount having a first section and a second section, the second section rotatably hinged to the first section; and one or more resilient shock absorbers, each shock absorber having a first end rotatably mounted to a first pivot point on the first section of the pivoting pole mount, and a second end rotatably mounted to a second pivot point on the second section of the pivoting pole mount; whereby, in use, the one or more shock absorbers counteract forces of rotation created when the first section and the second section of the pivoting pole mount are rotated relative to each other.

In an embodiment, the system further comprises one or more resilient compression springs adapted to counteract forces of rotation created when the first section and the second section of the pivoting pole mount are rotated relative to each other.

In another embodiment, each of the one or more springs surrounds each of the one or more shock absorbers, such that both counteract forces of rotation at the first pivot point and at the second pivot point.

In another embodiment, each of the one or more springs and each of the one or more shock absorbers is selected to counteract the force of a pole and a lighting fixture attached thereto in dependence upon the length of the pole and the combined weight of the pole and the lighting fixture.

In another aspect, there is provided a pivoting pole mount apparatus for safely lowering and raising a pole mounted lighting fixture, comprising: a first section adapted to receive and mount a pole; a second section adapted to receive and mount to a base, the second section rotatably hinged to the first section; and one or more resilient shock absorbers, each shock absorber having a first end rotatably mounted to a first pivot point on the first section of the pivoting pole mount, and a second end rotatably mounted to a second pivot point on the second section of the pivoting pole mount; whereby, in use, the one or more shock absorbers counteract forces of rotation created when the first section and the second section of the pivoting pole mount are rotated relative to each other.

In this respect, before explaining at least one embodiment of the apparatus and system of the present disclosure in detail, it is to be understood that the present apparatus and system is not limited in its application to the details of construction and to the arrangements of the components set forth in the following description or illustrated in the drawings. The present apparatus and system is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIGS. 1A and 1B show an illustrative example of a lighting fixture mounted on a pole, in which the pole is in turn mounted to a raised platform or catwalk;

FIGS. 2A and 2B show a detailed schematic diagram of a system and apparatus in accordance with an illustrative embodiment;

FIGS. 3A to 3F show the system and apparatus of FIGS. 2A and 2B in use, at various stages of rotation of a mounted pole from a vertical orientation to a generally horizontal orientation.

### DETAILED DESCRIPTION

As noted above, the present disclosure relates to a novel apparatus and system for safely lowering and raising a pole mounted lighting fixture.

In an embodiment the system includes a pivoting pole mount having a first section and a second section. The second section rotatably hinged to the first section. The system further includes one or more shock absorbers, each shock absorber having a first end rotatably mounted to a first pivot point on the first section of the pivoting pole mount, and a second end rotatably mounted to a second pivot point on the second section of the pivoting pole mount.

In use, when a pole mounted lighting fixture is lowered, the one or more shock absorbers absorb and counteract forces of rotation created when the first section and the second section of the pivoting pole mount are rotated relative to each other.

In another embodiment, the absorbers may include springs, such that they may assist in the raising of the pole mounted lighting fixture after work on the lighting fixture has been completed.

In another embodiment, a locking plate is used to lock the assembly into a vertical position when the pole is completely raised, and may be locked in position by a lock pin, for example.

By suitably selecting and calibrating the one or more shock absorbers to counteract the weight of the pole and the mounted lighting fixture, the pole lowering operation can be initiated and easily controlled by one person with one hand, and no longer requires the person to physically try to counteract the forces himself.

An illustrative embodiment of the system and apparatus will now be described in more detail with reference to the drawings.

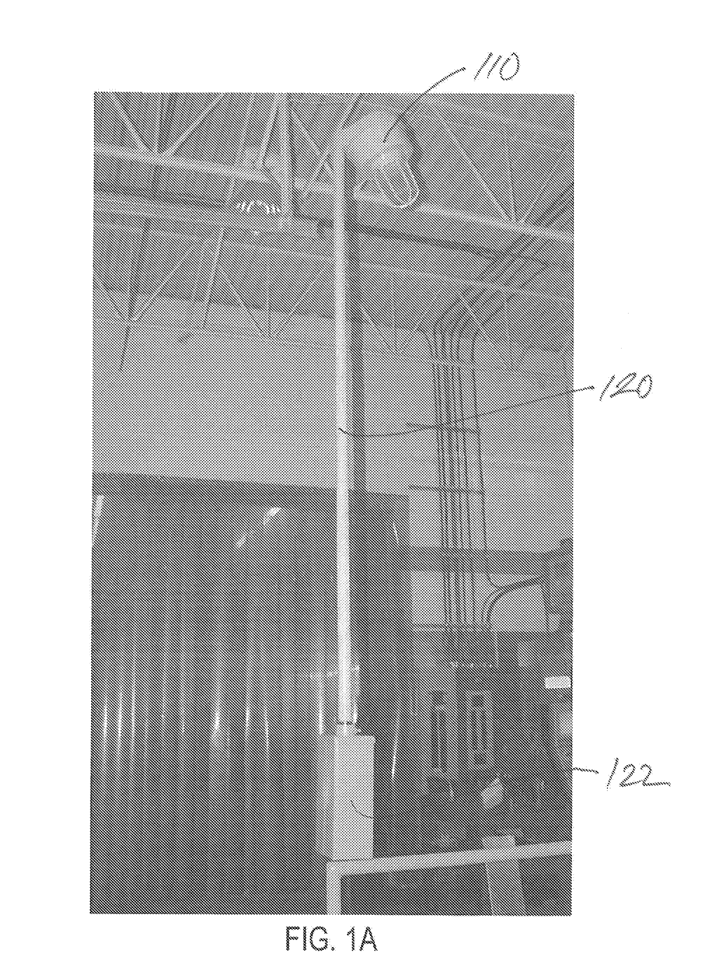

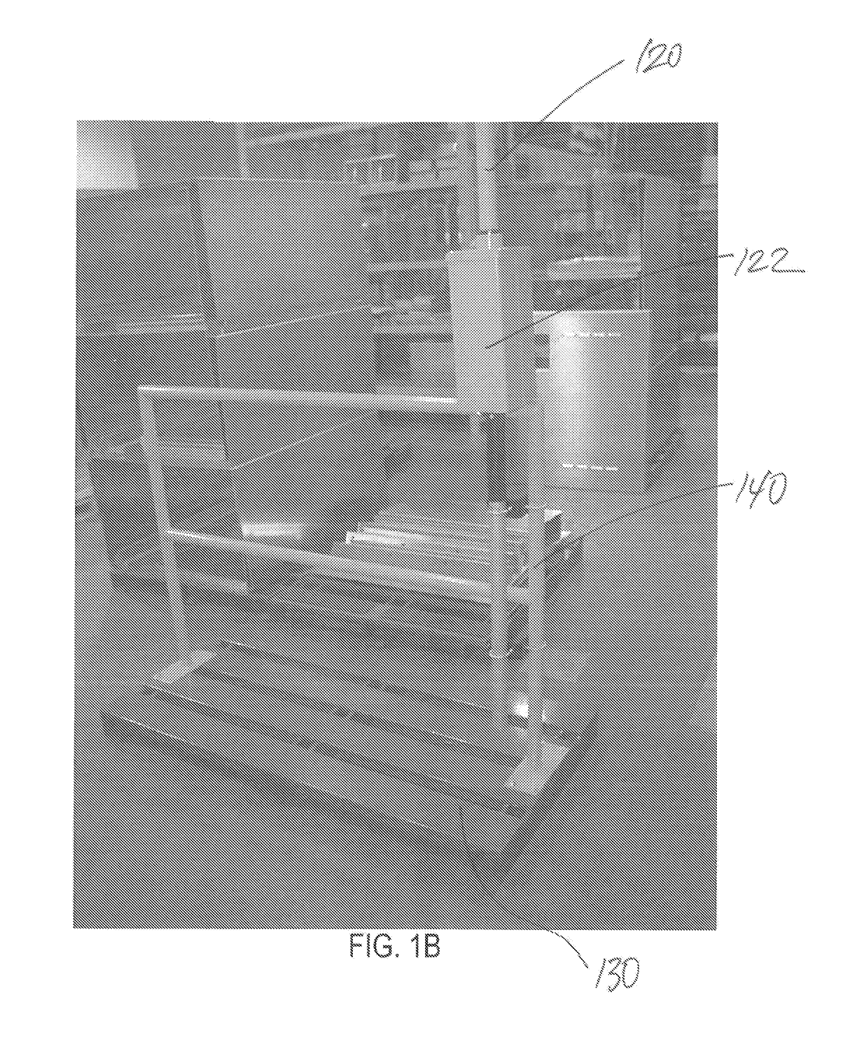

FIGS. 1A and 1B show an illustrative example of a lighting fixture 110 mounted on a pole 120, in which the pole 120 is in turn situated on a platform or catwalk 130 with a railing 140 that may be raised, although the platform 130 in this illustrative figure is of course at ground level. If the platform 130 is raised to heights as is common in various industrial applications, no boom lifts or scissor lifts could be used to safely reach the lighting fixture 110. However, by application of the present system and method, the lighting fixture 110 mounted on pole 120 can be safely lowered by the operation of one person to work on the lighting fixture 110, and safely raised again into operating position. In this illustrative example, a protective cover 122 is shown which may be used to protect the system and apparatus of the present invention when not operating.

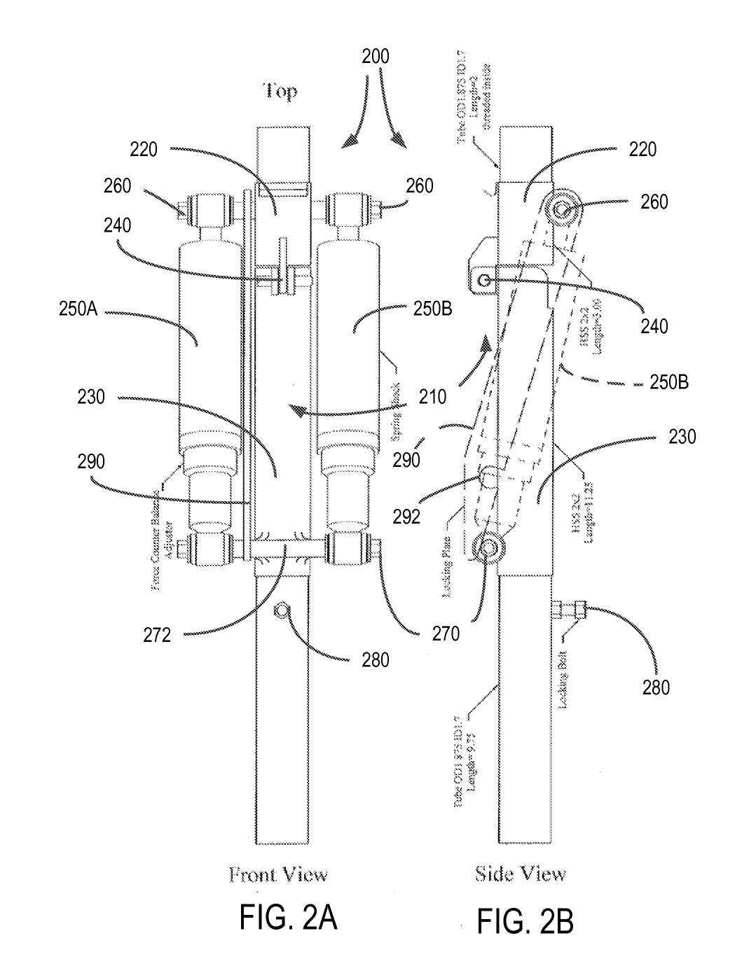

Now referring to FIGS. 2A and 2B, shown is a detailed schematic diagram of a system and apparatus 200 in accordance with an illustrative embodiment.

In this illustrative example, the system 200 includes a pivoting pole mount 210 having a first section 220 and a second section 230. The second section 220 is rotatably hinged to the first section 210 at a pole mount pivot point 240.

The system further includes one or more resilient shock absorbers 250A, 250B, each shock absorber 250A. 250B having a first end rotatably mounted to a first pivot 260 point on the first section 220 of the pivoting pole mount 210, and a second end rotatably mounted to a second pivot point 270 on the second section 230 of the pivoting pole mount. The second pivot point 270 in this example is a rod 272 which, in this illustrative example, is welded directly on to the second section 230, but it will be appreciated that other configurations may be used to mount the pivot point onto or within the second section 230.

While not shown in FIGS. 2A and 2B, the first section 220 of the pivoting pole mount 210 is adapted to receive pole 120, which may be secured by screw threading, or by other mounting means such as nuts and bolts, or by welding. It will also be appreciated that the pole 120 may itself be the first section 220 without the need to separately attach it to the pivot pole mount 210.

The second section 230 of the pivoting pole mount 210 is adapted to be mounted on a base pole (not shown) to secure the pivoting pole mount 210 in location on a platform 130, using a locking bolt 280, for example. It will also be appreciated that a base pole itself may be the second section 230 mounted directly to a platform 130 or other base to receive the pivoting pole mount 210.

In an embodiment, a locking plate 290 having a notch 292 is used to lock the pivoting pole mount 210 in a lowered position, such that the pivoting pole mount 210 cannot be further lowered without removing the locking plate 290. In this illustrative embodiment, the notch 292 engages rod 272 to provide a lower limit to how far the pivoting pole mount 210 may be pivoted, and allows the lighting fixture 110 to be stabilized in a lowered position as it is worked on. However, if it is desired to further lower the lighting fixture 110, the locking plate 290 could be swung out of the way, so that notch 292 does not engage rod 272.

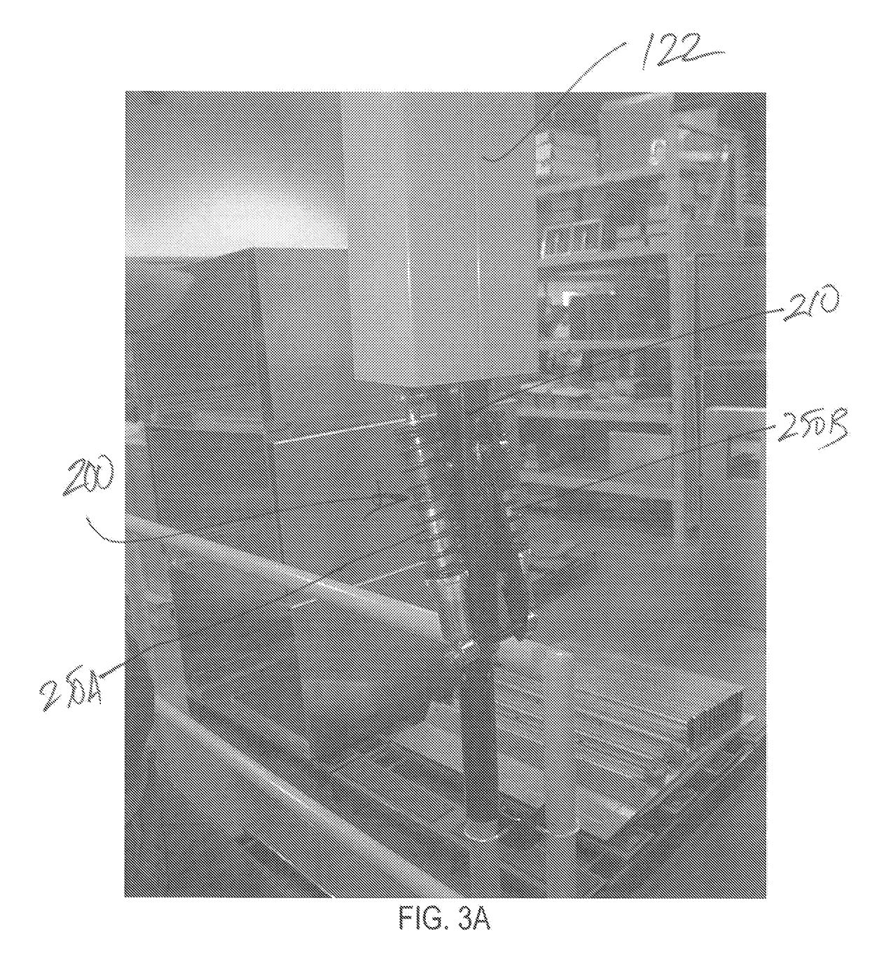

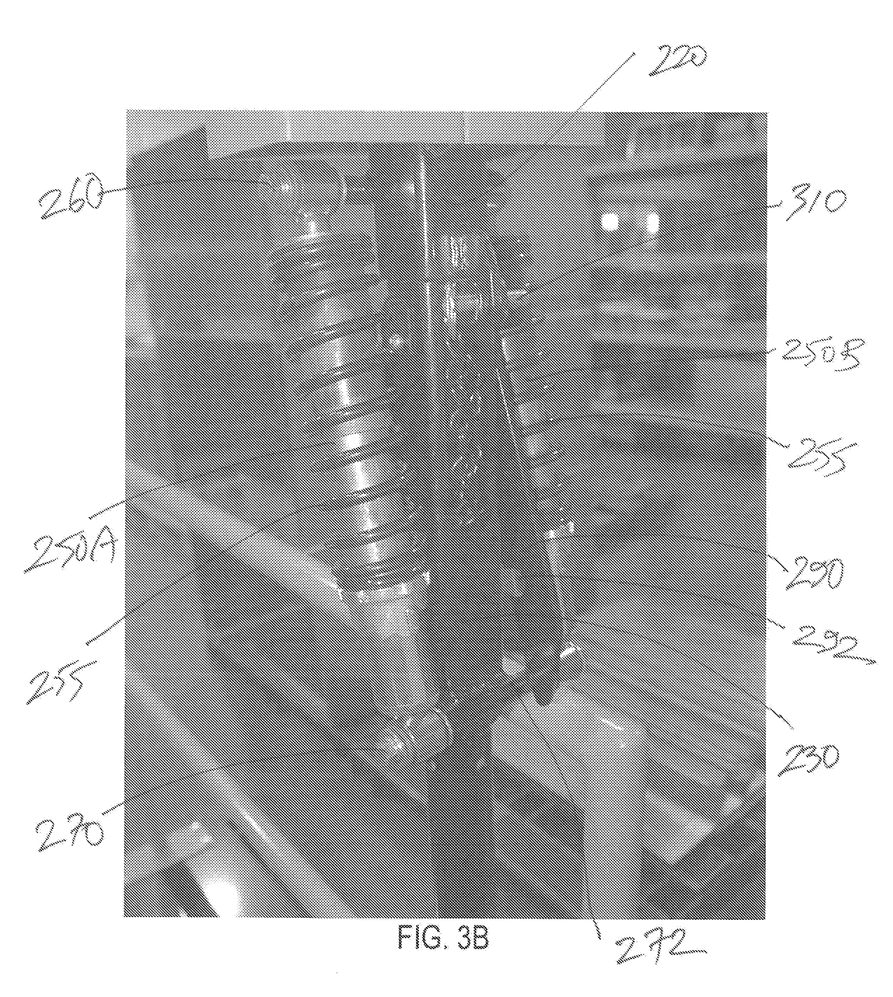

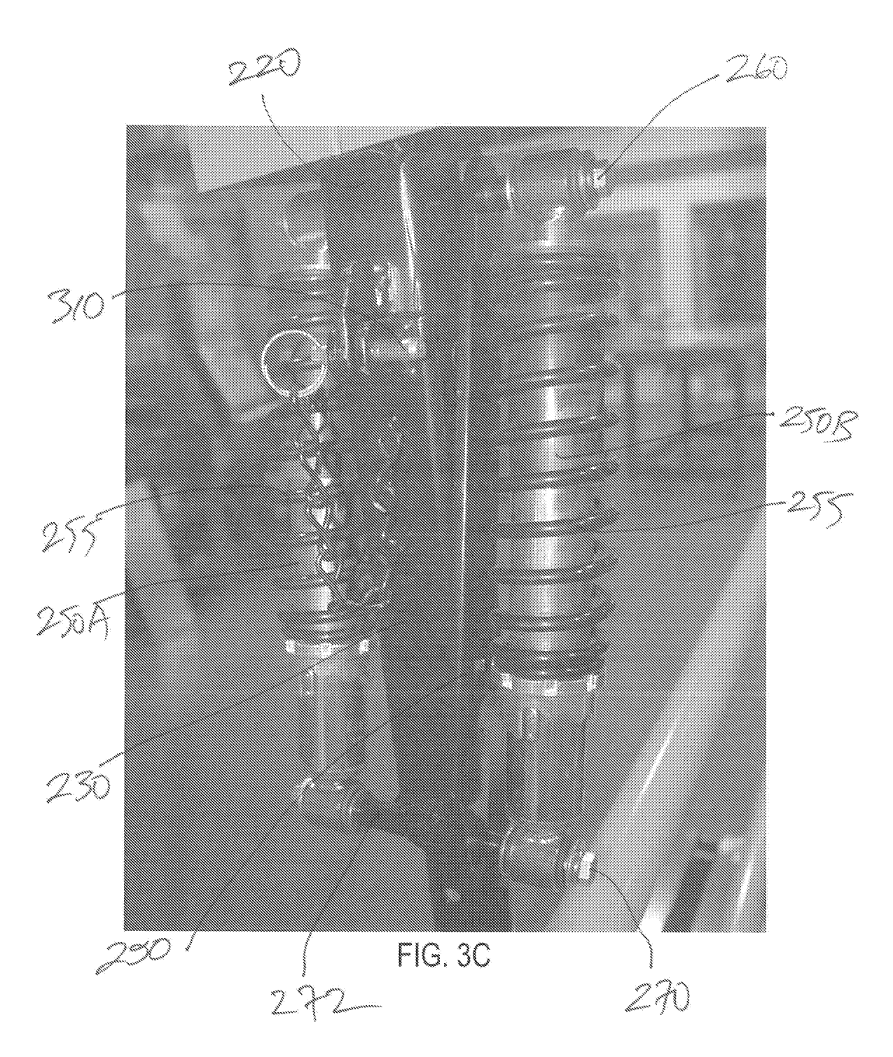

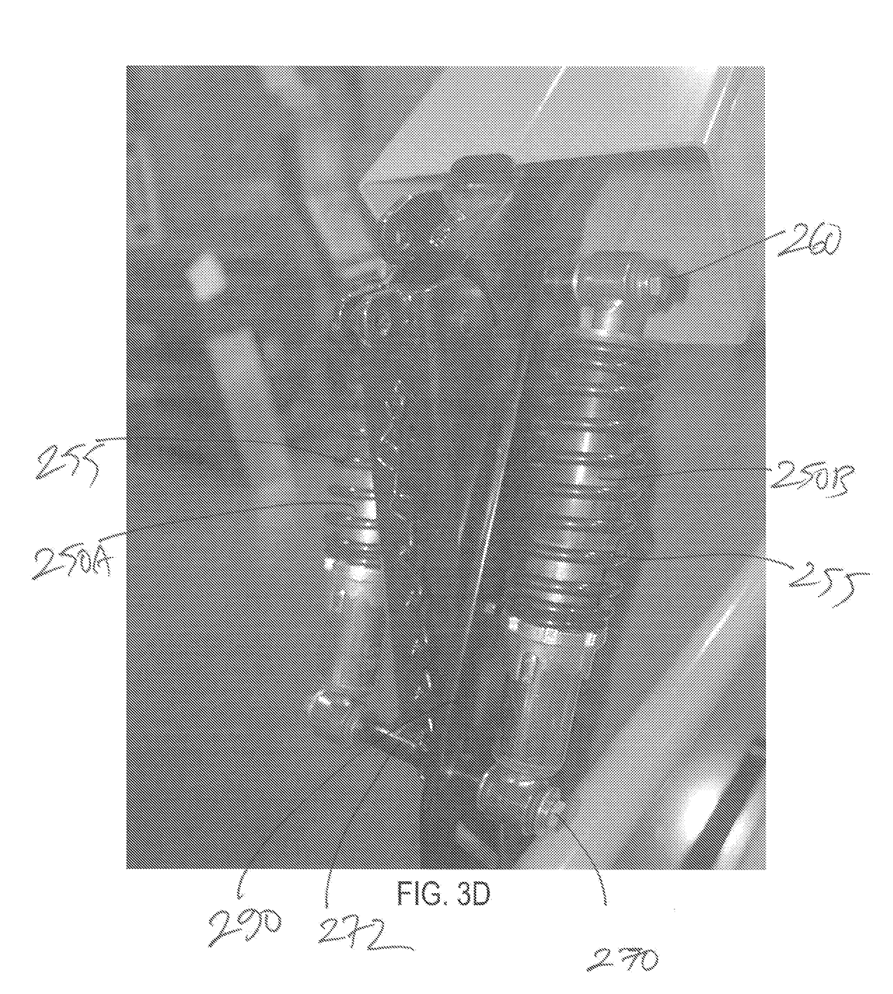

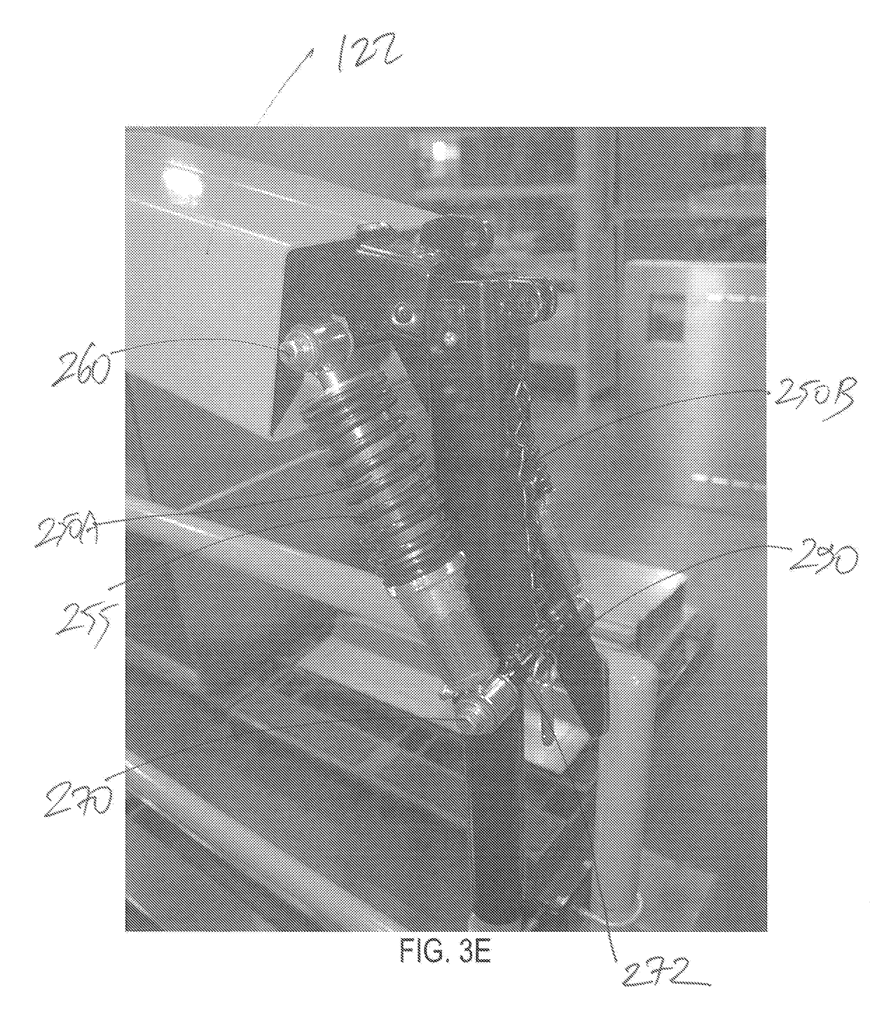

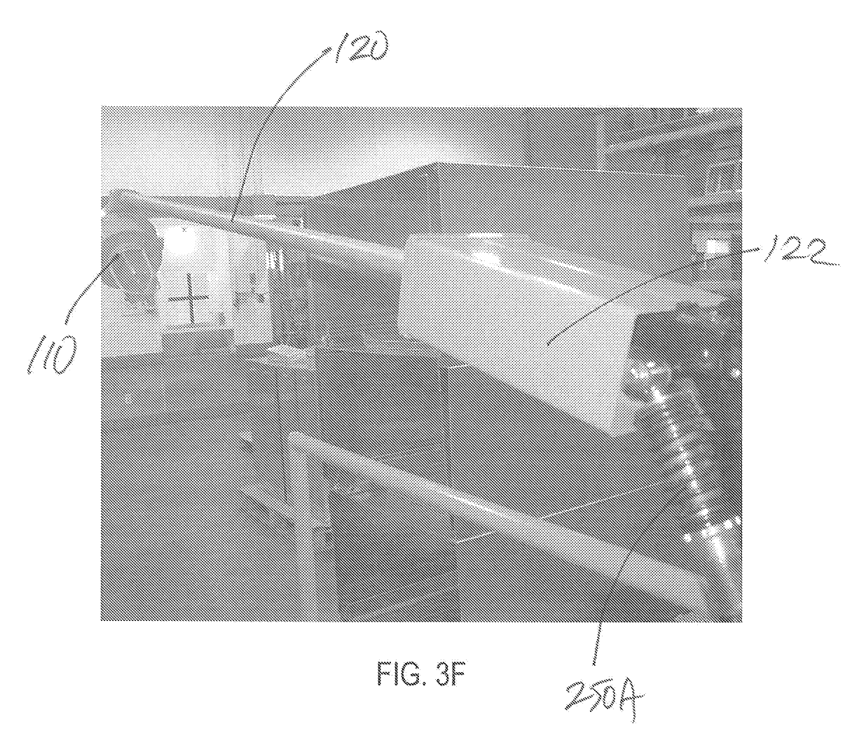

In another embodiment, a locking pin 310 (see FIGS. 3B and 3C) may be used to lock the pivoting pole mount 210 in a vertical position.

Now referring to FIGS. 3A to 3F, the illustrative system and apparatus of FIGS. 2A and 2B are shown in use, at various stages of rotation of a mounted pole 120 from a vertical orientation to a generally horizontal orientation.

As shown in FIG. 3A, protective cover 122 is shown in raised position to reveal system 200, which in this case shows a pair of hydraulic shock absorbers 250A, 250B mounted on either side of pivoting pole mount 210.

FIGS. 3B and 3C show closer views of the pivoting pole mount 210 with a first section 220 receiving pole 120, and a second section 230 mounted to a base pole. As shown in these detailed views, the pair of shock absorbers 250A, 250B further include resilient compression springs 255 which may be used to assist in absorbing a part of the forces, and may also assist in raising the pole 120 into a vertical position.

FIG. 3D shows the locking pin 310 removed and the pivoting pole mount 210 partly rotated. In this position, the distance between the first pivot point 260 and second pivot point 270 has decreased from the vertical position shown in FIGS. 3A to 3C. Therefore, the first and second shock absorbers 250A, 250B are now in a compressed state. The springs 255 are also compressed, and resiliently acting against the forces of rotation caused by the pole 120 and lighting fixture 110.

FIGS. 3E and 3F show the pivoting pole mount 210 further rotated to be even lower. Locking plate 290 has now engaged rod 272, as earlier described, and the pole 120 and lighting fixture 110 cannot be lowered further, unless the locking plate 290 is swung out of the way.

The distance between the first pivot point 260 and second pivot point 270 has decreased even further than shown in FIG. 3D. Therefore, the first and second shock absorbers 250A, 250B and springs 255 are now in a further compressed state, providing a greater force to counter-balance the increased rotational force of the pole 120 and lighting fixture 110.

Advantageously the increasing counteracting force of the first and second shock absorbers 250A, 250B and springs 255 effectively counteract the increasing rotational force applied by the pole 120 and lighting fixture 110, such that the entire pole and lighting fixture is well balanced throughout its range of motion. With proper selection of suitable shock absorbers 250A, 250B and springs 255, and calibration based on the weight of the pole 120 and the lighting fixture 110, one person can easily and safely lower and raise the lighting fixture 110 for servicing.

In an embodiment, the system 200 may be adapted to be retrofitted in existing lighting systems by providing a suitable mount for mounting poles to the first section 220 of the pivoting pole mount 210, and for mounting the second section 230 of the pivoting pole mount to any type of pipe, rail, pad, or poling support. Alternatively, the system 200 may comprise an entire assembly such that a pole 120 is itself the first section 220, or any type of base pole or mounting assembly is itself embodied in the second section 230. Any combination of these configurations is also possible.

Furthermore, while hydraulic shock absorbers and springs have been shown by way of illustration, it will be appreciated that any other suitable shock absorbing means may be used to produce the counteracting force, provided that the force increases proportionally to the amount of rotation of the pole 120 and lighting fixture 110.

Thus, in an aspect, there is provided a system for safely lowering and raising a pole mounted lighting fixture, comprising: a pivoting pole mount having a first section and a second section, the second section rotatably hinged to the first section; and one or more resilient shock absorbers, each shock absorber having a first end rotatably mounted to a first pivot point on the first section of the pivoting pole mount, and a second end rotatably mounted to a second pivot point on the second section of the pivoting pole mount; whereby, in use, the one or more shock absorbers counteract forces of rotation created when the first section and the second section of the pivoting pole mount are rotated relative to each other.

In an embodiment, the system further comprises one or more resilient compression springs adapted to counteract forces of rotation created when the first section and the second section of the pivoting pole mount are rotated relative to each other.

In another embodiment, each of the one or more springs surrounds each of the one or more shock absorbers, such that both counteract forces of rotation at the first pivot point and at the second pivot point.

In another embodiment, each of the one or more springs and each of the one or more shock absorbers is selected to counteract the force of a pole and a lighting fixture attached thereto in dependence upon the length of the pole and the combined weight of the pole and the lighting fixture.

In another embodiment, the system further comprises a locking plate adapted to engage a stop such that the first section and the second section of the pivoting pole mount cannot be pivoted further.

In another embodiment, the locking plate is adapted to pivot, and includes one or more notches adapted to engage a rod acting as the stop.

In another embodiment, the locking plate is adapted to pivot from the first pivot point, and the rod acting as the stop coincides with the second pivot point.

In another embodiment, the locking plate is further adapted to receive a locking pin to secure the locking plate in position.

In another aspect, there is provided a pivoting pole mount apparatus for safely lowering and raising a pole mounted lighting fixture, comprising: a first section adapted to receive and mount a pole; a second section adapted to receive and mount to a base, the second section rotatably hinged to the first section; and one or more resilient shock absorbers, each shock absorber having a first end rotatably mounted to a first pivot point on the first section of the pivoting pole mount, and a second end rotatably mounted to a second pivot point on the second section of the pivoting pole mount; whereby, in use, the one or more shock absorbers counteract forces of rotation created when the first section and the second section of the pivoting pole mount are rotated relative to each other.

It should be understood that further enhancements to the disclosed system and method are envisioned.

1. A system for safely lowering and raising a pole mounted lighting fixture, comprising:
a pivoting pole mount having a first section and a second section, the second section rotatably hinged to the first section; and
one or more resilient shock absorbers, each shock absorber having a first end rotatably mounted to a first pivot point on the first section of the pivoting pole mount, and a second end rotatably mounted to a second pivot point on the second section of the pivoting pole mount;
whereby, in use, the one or more shock absorbers counteract forces of rotation created when the first section and the second section of the pivoting pole mount are rotated relative to each other.

2. The system of claim 1, further comprising one or more resilient compression springs adapted to counteract forces of rotation created when the first section and the second section of the pivoting pole mount are rotated relative to each other.

3. The system of claim 2, wherein each of the one or more springs surrounds each of the one or more shock absorbers, such that both counteract forces of rotation at the first pivot point and at the second pivot point.

4. The system of claim 3, wherein each of the one or more springs and each of the one or more shock absorbers is selected to counteract the force of a pole and a lighting fixture attached thereto in dependence upon the length of the pole and the combined weight of the pole and the lighting fixture.

5. The system of claim 1, further comprising a locking plate adapted to engage a stop such that the first section and the second section of the pivoting pole mount cannot be pivoted further.

6. The system of claim 5, wherein the locking plate is adapted to pivot, and includes one or more notches adapted to engage a rod acting as the stop.

7. The system of claim 6, wherein the locking plate is adapted to pivot from the first pivot point, and the rod acting as the stop coincides with the second pivot point.

8. The system of claim 6, wherein the locking plate is further adapted to receive a locking pin to secure the locking plate in position.

9. A pivoting pole mount apparatus for safely lowering and raising a pole mounted lighting fixture, comprising:
a first section adapted to receive and mount a pole;
a second section adapted to receive and mount to a base, the second section rotatably hinged to the first section; and
one or more resilient shock absorbers, each shock absorber having a first end rotatably mounted to a first pivot point on the first section of the pivoting pole mount, and a second end rotatably mounted to a second pivot point on the second section of the pivoting pole mount;
whereby, in use, the one or more shock absorbers counteract forces of rotation created when the first section and the second section of the pivoting pole mount are rotated relative to each other.

10. The pivoting pole mount apparatus of claim 9, further comprising one or more resilient compression springs adapted to counteract forces of rotation created when the first section and the second section of the pivoting pole mount are rotated relative to each other.

11. The pivoting pole mount apparatus of claim 10, wherein each of the one or more springs surrounds each of the one or more shock absorbers, such that both counteract forces of rotation at the first pivot point and at the second pivot point.

12. The pivoting pole mount apparatus of claim 11, wherein each of the one or more springs and each of the one or more shock absorbers is selected to counteract the force of a pole and a lighting fixture attached thereto in dependence upon the length of the pole and the combined weight of the pole and the lighting fixture.

13. The pivoting pole mount apparatus of claim 9, further comprising a locking plate adapted to engage a stop such that the first section and the second section of the pivoting pole mount cannot be pivoted further.

14. The pivoting pole mount apparatus of claim 13, wherein the locking plate is adapted to pivot, and includes one or more notches adapted to engage a rod acting as the stop.

15. The pivoting pole mount apparatus of claim 14, wherein the locking plate is adapted to pivot from the first pivot point, and the rod acting as the stop coincides with the second pivot point.

16. The pivoting pole mount apparatus of claim 15, wherein the locking plate is further adapted to receive a locking pin to secure the locking plate in position.
